(19) United States
(12) Patent Application Publication
(10) Pub. No.: US 2023/0150295 A1
(43) Pub. Date: May 18, 2023

(54) REUSABLE CHALKBOARD KIT

(71) Applicant: Jeremy Thomas Drake, Winter Park, FL (US)

(72) Inventor: Jeremy Thomas Drake, Winter Park, FL (US)

(21) Appl. No.: 17/524,921

(22) Filed: Nov. 12, 2021

(51) Int. Cl. B43L 1/08; B43L 1/10; B43L 21/00

(52) U.S. Cl. CPC B43L 1/08; B43L 1/10; B43L 21/00

(57) ABSTRACT

A reusable chalkboard kit is disclosed. The kit includes a deformable vinyl substrate, an underlayment layer configured to allow the deformable vinyl substrate to frictionally engage a stabilizing surface, at least one writing implement, and an eraser component configured to remove one or more markings generated by the at least one writing implement. The deformable vinyl substrate further includes an extended configuration to support marking/drawing on the deformable vinyl substrate and a storage configuration to support stowing of the kit.

### FIELD OF THE DISCLOSURE

Aspects of the present disclosure generally relate to a surface for drawing or writing. More particularly, this invention relates to a deformable and reusable portable chalkboard kit.

### BACKGROUND OF THE DISCLOSURE

Writing and drawing utilizing chalk is a form of expression that dates back to the Prehistoric era. Throughout history utilizing chalk has migrated to various areas including art studios, classrooms, streets, etc. Recently, chalk has become popular, most significantly, among adolescents, who apply chalk to sidewalks, i.e., writing and drawing, because there is no need to clean it up. Due to its inherent non-permanent nature, rain or lawn sprinklers are usually enough to wipe the sidewalk surfaces clean. However, a major drawback to chalk writing and drawing on sidewalks is that it is an indicator that children live in a particular house that corresponds to the marked-up sidewalk. This can be a luring factor to neighborhoods for child predators, sex offenders, and other individuals with malicious intentions preying on adolescents.

One current approach to circumvent this issue is to utilize chalkboards within the household. For example, classroom chalkboards may be utilized upon the walls of the household. However, the inherent chalk dust produced by chalk when pressed upon a vertical planar surface structure of a chalkboard results in a significant amount of chalk dust to be cleaned up. Also, there may be an increased risk of respiratory issues caused by extended inhalation of chalk dust that results from erasing chalk marks from a chalkboard, which falls from the board into the atmosphere. In addition, traditional chalkboards are generally rigid and, when provided in certain sizes, become burdensome to move and store due to the weight and size. They also require a substantial amount of blank wall space, which is often at a premium in homes.

What is needed is a chalkboard kit configured to circumvent the aforementioned issues.

### SUMMARY OF THE DISCLOSURE

The invention provides a reusable chalkboard kit that overcomes the hereinafore-mentioned disadvantages of the heretofore-known devices and methods of this general type.

In some embodiments, a reusable chalkboard kit is provided, the kit including a deformable vinyl substrate; an underlayment layer configured to allow the deformable vinyl substrate to frictionally engage a stabilizing surface; at least one writing implement; and an eraser component configured to remove one or more markings on the deformable vinyl substrate generated by the at least one writing implement.

In some embodiments, the deformable vinyl substrate includes a first side and a second side opposing the first side configured to house or retain the underlayment layer.

In some embodiments, the underlayment layer has a weight that holds the deformable vinyl substrate in a shape that substantially matches a surface upon which the underlayment layer rests.

In some embodiments, the second side is configured to frictionally engage the stabilizing surface via the underlayment layer.

In some embodiments, the underlayment layer includes a plurality of weights which may include adhesives and the stabilizing surface includes a carpet structure.

In some embodiments, the eraser component is a fabric-based cleaning cloth configured to eliminate the one or more markings.

In some embodiments, the deformable vinyl substrate is generally flat and configured to retain the one or more markings.

In some embodiments, the at least one writing implement are chalk-based.

In some embodiments, the deformable vinyl substrate comprises an extended configuration and a storage configuration in which the deformable vinyl substrate is configured to be rolled up in order to enter into the storage configuration.

In some embodiments, a method of using a reusable chalkboard kit is presented in which the method includes unrolling a deformable vinyl substrate into an extended configuration; attaching or retaining an underlayment layer to a second side of the deformable vinyl substrate; deformable vinyl substrate frictionally engaging a stabilizing surface via the underlayment layer; applying one or more markings to a first side of the deformable vinyl substrate via a at least one writing implement; removing the one or more markings from the first side of the deformable vinyl substrate; and rolling the deformable vinyl substrate into a storage configuration.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective view of the contents of a reusable chalkboard kit, according to an exemplary embodiment;

FIG. 2 is a perspective view of the bottom surface of a deformable vinyl substrate of the reusable chalkboard kit of FIG. 1, according to an exemplary embodiment;

FIG. 3 is a perspective view of the top surface of a deformable vinyl substrate component of the reusable chalkboard kit of FIG. 1 in an extended configuration on a carpet surface, according to an exemplary embodiment;

FIG. 4 is a perspective view of the deformable vinyl substrate of the reusable chalkboard kit of FIG. 1 in a storage configuration, according to an exemplary embodiment; and

FIG. 5 is a flow chart diagrammatically illustrating a method for utilizing a reusable chalkboard kit, according to an exemplar embodiment.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient reusable chalkboard kit configured to include a deformable vinyl substrate; at least one chalk-based writing implement; and an eraser component configured to remove markings from the deformable vinyl substrate due to the use of the at least one writing implement on the substrate. The deformable vinyl substrate has an underlayment layer capable of frictionally engaging a floor surface.

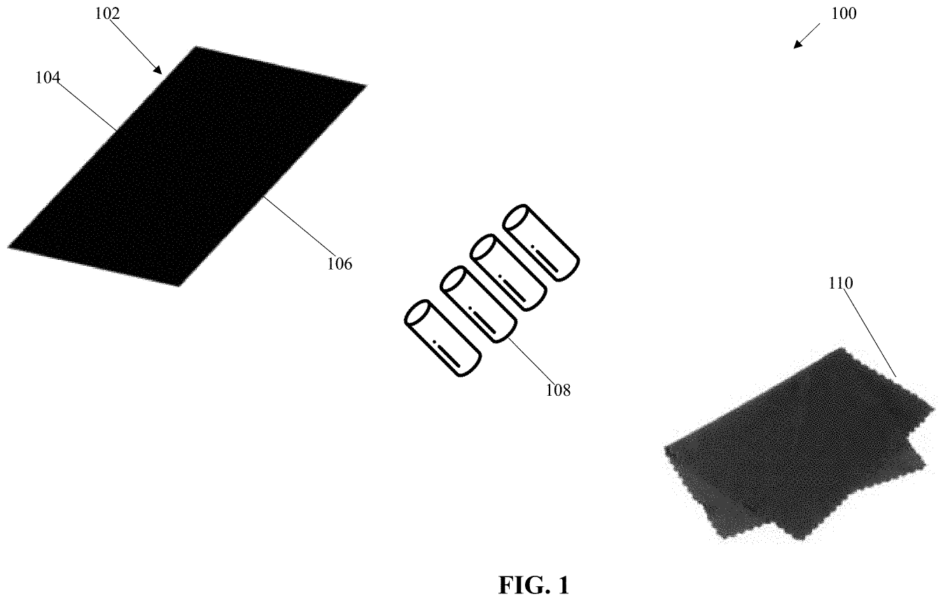

Referring now to FIG. 1, a reusable chalkboard kit 100 is depicted, according to an exemplary embodiment. Kit 100 includes a deformable vinyl substrate 102. In some embodiments, deformable vinyl substrate 102 includes a first side 104 and a second side 106. In some embodiments, first side 104 and second side 106 are opposing and at least one of the sides 104, 106 are configured to receive one or more markings, as explained below. Kit 100 further includes at least one writing implement 108 configured to generate one or markings on the deformable vinyl substrate. An eraser component 110, e.g., a cloth, is configured to remove the one or more markings from the deformable vinyl substrate 102. It is to be understood that deformable vinyl substrate 102 may be any applicable shape, width, length, or applicable dimension and various configurations of deformable vinyl substrate 102 are within the spirit and scope of the disclosure. In some embodiments, the at least one writing implement 108 is composed of chalk or chalk-based material; however, at least one writing implement 108 may be chalk markers, spray chalk, squeeze chalk, sidewalk paint chalk, or any other applicable writing implement configured to write/draw on chalkboards and/or synthetic plastic polymer.

In some embodiments, eraser component 110 is a fabric-based cleaning cloth including but not limited to cotton, velvet, silk, wool, denim, satin, felt, rayon, any combination thereof, or any other applicable fabric. However, eraser component 110 is designed and configured to remove one or more markings from deformable vinyl substrate 102 without emitting chalk dust from at least one writing implement 108 in the air. In some embodiments, eraser component 110 may be a set of diluted wipes configured to remove the one or more markings in a manner that does not leave chalk residue. In some embodiments, the set of diluted wipes may be fabric-based which carry an acid including but not limited to vinegar, hydrochloric, or any other applicable acid or derivative of acid that effectively eliminates or removes chalk from the active deformable vinyl substrate.

It is to be understood that deformable vinyl substrate 102 is configured to be composed of polyvinyl chloride, polypropylene, polyethylene, adhesive vinyl, heat transfer vinyl, or any other applicable type of material known to those of ordinary skill in the art. Deformable vinyl substrate 102 is designed to be composed of flexible and durable material that allows the deformable vinyl substrate 102 to be sturdy enough to write/draw on but also ductile enough to be collapsible/compactable or rollable. In some embodiments, deformable vinyl substrate 102 includes an extended configuration (typically a flat configuration) and a storage configuration. In the extended configuration, deformable vinyl substrate 102 is laid out rendering a generally flat, writable surface. It is to be understood that in the preferred embodiment deformable vinyl substrate 102 extends horizontally.

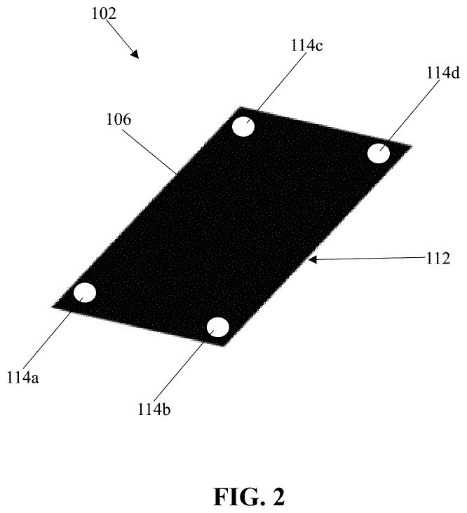

Referring now to FIG. 2, a bottom view of deformable vinyl substrate 102 is depicted, according to an exemplary embodiment. In some embodiments, deformable substrate 102 includes an underlayment layer 112 which is configured to allow deformable vinyl substrate 102 to frictionally engage a stabilizing surface. It is to be understood that, as described herein, the stabilizing surface is any applicable surface configured to support and allow deformable vinyl substrate 102 to lay atop the stabilizing surface in order to effectively receive one or more markings by the writing implements without movement of deformable vinyl substrate 102 on the stabilizing surface. In some embodiments, underlayment layer 112 is allocated among second side 106. In some embodiments, underlayment layer 112 includes a weight configured to hold deformable vinyl substrate 102 in a shape that substantially matches the stabilizing surface upon which vinyl substrate 102 and/or underlayment layer 112 rests on. The second side 106 is configured to come into proximate or direct contact with the stabilizing surface, thereby allowing deformable vinyl substrate 102 to frictionally engage the stabilizing surface. In some embodiments, second side 106 includes the weight of underlayment layer 112 in which underlayment layer 112 may include a plurality of marginally allocated weights 114a-n (where n is any number greater than a) located at an applicable corner of deformable vinyl substrate 102. It is to be understood that the plurality of marginally allocated weights 114a-n are configured to be weighted elements that may be affixed and/or attached to deformable vinyl substrate 102 allowing it to rest atop the stabilizing surface.

In some embodiments, the plurality of marginally allocated weights 114a-n are configured to be in contact at two or more contact points on the first side 104 to ensure that deformable vinyl substrate 102 is properly frictionally engaged at two or more points for an optimal stable resting on the stabilizing surface. In some embodiments, weights 114a-n may include adhesives, releasable glue, magnets, snaps, clasps, hooks, hook & loop (VELCRO®), or any other applicable mechanism for assisting the maintenance of the frictional engagement between substrate 102 to the stabilizing surface known to those of ordinary skill in the art. In some embodiments, the underlayment layer 112 is embedded in second side 106; however, in other embodiments, the underlayment layer 112 is allocate along deformable vinyl substrate 102. The underlayment layer 112 is designed and configured to provide a secured engagement of deformable vinyl substrate 102 onto the stabilizing surface in a manner such that deformable vinyl substrate 102 may not be removed from the stabilizing surface without a substantial amount of pressure or force applied by the user, such as a pulling force. It is to be understood that other pressures and forces applied to deformable vinyl substrate 102 may be employed to remove second side 106 from the stabilizing surface are within the spirit and scope of the disclosure.

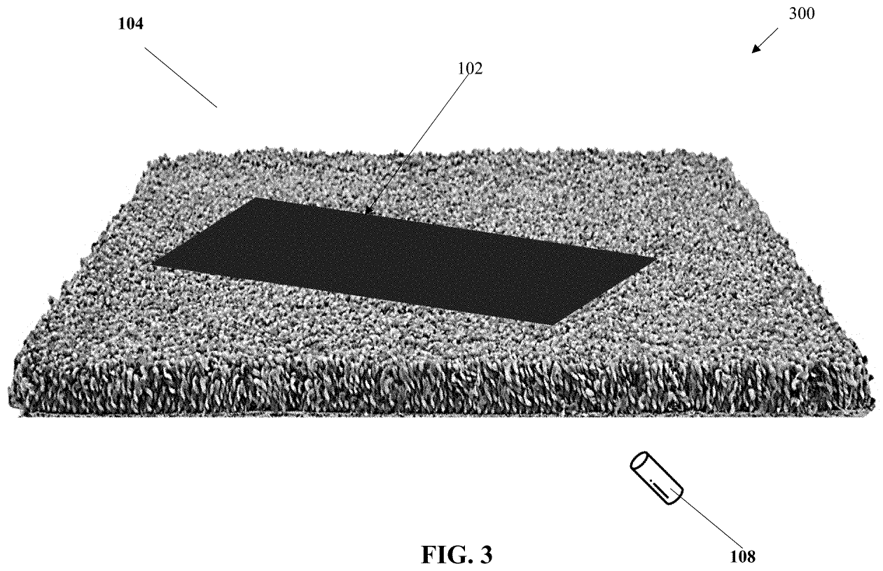

Referring now to FIG. 3, an environment 300 for deformable vinyl substrate 102 is depicted, according to an exemplary embodiment. As depicted, the stabilizing surface of environment 300 is a carpet flooring in which deformable vinyl substrate 102 is securely and sturdily frictionally engaging the stabilizing carpet surface. It is to be understood that the stabilizing surface may include, but is not limited to, carpet, tile, porcelain, vinyl, hardwood, bamboo, concrete, slate, linoleum, any combination thereof, or any other applicable surface known to those of ordinary skill in the art. In some embodiments, deformable vinyl substrate 102 may include one or more raised edges, corners, or borders configured to prevent items and derived particles associated with items resting thereon from rolling away, off, or escaping from active deformable vinyl substrate 102. In some embodiments, at least one writing implement 108 may include one or more magnetic components and the raised edges, corners, or borders may include complementary magnetic components allowing writing implements 108 to attach, via magnetic force, to the raised edges, corners, or borders. In some embodiments, the raised edges, corners, borders, or magnetic components of deformable vinyl substrate 102 may be collapsible or removable subject to the configuration of deformable vinyl substrate 102.

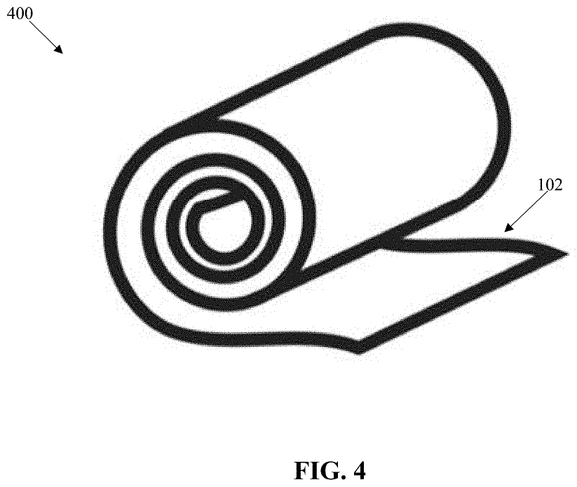

Referring now to FIG. 4, a storage configuration 400 of deformable vinyl substrate 102 is depicted, according to an exemplary embodiment. In this exemplary embodiment, the storage configuration is a rolled-up state of substrate 102. Storage configuration 400 is designed and configured to allow deformable vinyl substrate 102 to be put away in confined spaces. It is to be understood that in some embodiments the raised edges, corners, or borders that oppose each other may be the starting points of a rolling action from the extended, generally flat configuration of deformable vinyl substrate 102 (see FIG. 1), in which two opposing edges of deformable vinyl substrate are rolled inward in order to meet at a central inboard location of substrate 102. In some embodiments, substrate 102 includes one or more collapsible depressions or detents configured to enable folding and rolling of deformable vinyl substrate 102. In a preferred embodiment, deformable vinyl substrate 102 is rolled from a first end of deformable vinyl substrate 102 resulting in the first end being tucked, rolled, layered, and covered by a second end of deformable vinyl substrate 102.

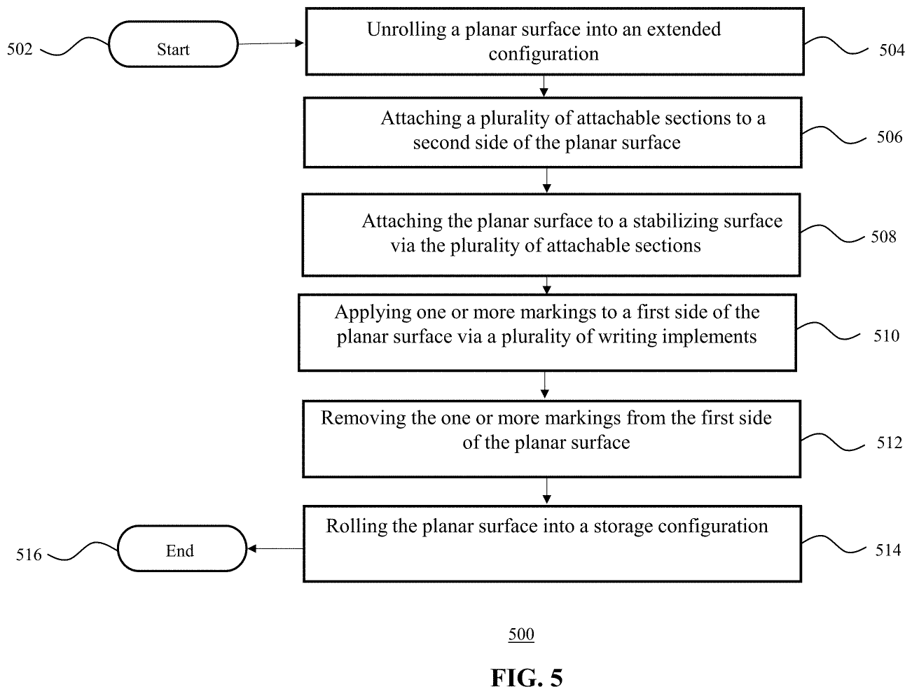

Referring now to FIG. 5, a method 500 of utilizing a reusable chalkboard kit 100 is depicted, according to an exemplary embodiment. The process begins at step 502 in which deformable vinyl substrate 102 is presumed to be in the storage configuration, e.g., as shown in FIG. 4. At step 504, deformable vinyl substrate 102 is unrolled to the extended configuration allowing deformable vinyl substrate 102 to extend across and atop the stabilizing surface, e.g., as shown in FIG. 3. Both deformable vinyl substrate 102 and the stabilizing surface being oriented in a parallel manner. At step 506, the underlayment layer 112 is allocated to second side 106. It is to be understood that, in some embodiments, underlayment layer 112 is integrated into at least one of sides 104 and 106 of substrate 102. At step 508, deformable vinyl substrate 102 is frictionally engaged with the stabilizing surface, e.g., via the underlayment layer 112, but such a layer is not necessary. At step 510, one or more markings are applied to first side 104 via one or more writing implements 108. At step 512, once the user is done utilizing first side 104, the markings are removed from first side 104 by the user via eraser component 110. At step 514, deformable vinyl substrate 102 is converted from its extended, generally flat configuration, to the storage configuration by rolling deformable vinyl substrate 102 up in the manner described above in order to properly store kit 100 in a compact shape, e.g., as shown in FIG. 4. At step 516, the process ends.

The claims appended hereto are meant to cover all modifications and changes within the scope and spirit of the present invention.

What is claimed is:

1. A reusable chalkboard kit, the kit comprising:
a deformable vinyl substrate;
at least one chalk-based writing implement; and
an eraser component configured to remove markings from the deformable vinyl substrate generated by the at least one chalk-based implement.

2. The kit of claim 1, wherein the deformable vinyl substrate has an underlayment layer capable of frictionally engaging a floor surface.

3. The kit of claim 2, wherein the underlayment layer has a weight that holds the deformable vinyl substrate in a shape that substantially matches a surface upon which the underlayment layer rests.

4. The kit of claim 1, further comprising:
a plurality of weighted elements coupled to the deformable vinyl substrate, the plurality of weighted elements operable to hold the deformable vinyl substrate in a shape that substantially matches a surface upon which the deformable vinyl substrate rests.

5. The kit of claim 1, wherein the deformable vinyl substrate includes a first side and a second side, and at least one of the first side and the second side is composed of one or more of acetate butyrate, polyvinyl chloride, polyethylene, or polypropylene.

6. The kit of claim 5, wherein the second side is configured to frictionally engage a surface via the underlayment layer.

7. The kit of claim 1, wherein the eraser component is a fabric-based cleaning cloth configured to eliminate the one or more markings.

8. The kit of claim 1, wherein the at least one chalk-based writing implement is a plurality of different colored pieces of chalk.

9. The kit of claim 1, wherein the deformable vinyl substrate includes an extended configuration and a storage configuration.

10. The kit of claim 9, wherein the deformable vinyl substrate is configured to be rolled up in order to enter into the storage configuration.
